(19) United States
(12) Patent Application Publication
(10) Pub. No.: US 2026/0356136 A1
(43) Pub. Date: Nov. 12, 2026

(54) ESTIMATING TIRE PRESSURE

(71) Applicant: Robert Bosch GmbH, Stuttgart (DE)

(72) Inventors: Joseph Sangyeon Park, Saint Clair Shores, MI (US); Harshwardhan Dilip Karve, Commerce Township, MI (US)

(21) Appl. No.: 19/205,544

(22) Filed: May 12, 2025

(51) Int. Cl. B60C 23/02

(52) U.S. Cl. CPC B60C 23/02

(57) ABSTRACT

A system for estimating tire pressure. In one example, the system includes an electronic processor configured to control a motor to move a mechanical component of a vehicle left and right, where the mechanical component is connected to a wheel of the vehicle. The electronic processor is also configured to, when the mechanical component is moving, determine a position of the mechanical component, estimate, using data from one or more steering system sensors, mechanical component force, and determine a pressure indicator value based on the estimated mechanical component force and the position of the mechanical component. The electronic processor is further configured to determine, based on the pressure indicator value, an estimated tire pressure using a mapping of pressure indicator values to tire pressures.

### SUMMARY

Driving a vehicle with tires that are underinflated (often referred to as a low tire pressure situations) can result in tire damage. In many vehicles today, tire pressure is measured using tire pressure measurement sensors (TPMS). TPMS may be utilized to provide an indication of low tire pressure to the driver when the vehicle starts up. However, TPMS sensors are expensive and can become faulty over time and require replacement. Methods also exist for estimating tire pressure while a vehicle performs normal driving maneuvers by using, for example, steering or wheel speed sensors. However, these methods cannot be performed upon vehicle start up, they may only be performed once the vehicle begins driving.

In vehicles equipped with a steering system utilizing an electric motor (for example, a steer by wire (SbW) steering system, a single wheel steering system, or a rear wheel steering system), tire pressure estimation may be accomplished using the implementations described herein. The implementations described herein, among other things, allow tire pressure to be estimated without the use of TPMS sensors and upon vehicle start up (while the vehicle is in park and prior to the vehicle being driven). The implementations described herein, among other things, eliminate the need for TPMS mounted on wheels in vehicles equipped with an electronic motor, while still allowing for early detection of low tire pressure.

One implementation described herein provides a system for estimating tire pressure. The system includes an electronic processor. In one instance, the electronic processor is configured to control a motor to move a mechanical component of a vehicle left and right. The mechanical component is connected to a wheel of the vehicle. The electronic processor is also configured to, when the mechanical component is moving, determine a position of the mechanical component; estimate, using data from one or more steering system sensors, mechanical component force; and determine a pressure indicator value based on the estimated mechanical component force and the position of the mechanical component. The electronic processor is further configured to determine, based on the pressure indicator value, an estimated tire pressure using a mapping of pressure indicator values to tire pressures.

Another implementation described herein provides a method for estimating tire pressure. In one instance, the method includes controlling a motor to move a mechanical component of a vehicle left and right. The mechanical component is connected to a wheel of the vehicle. The method also includes, when the mechanical component is moving, determining a position of the mechanical component; estimating, using data from one or more steering system sensors, mechanical component force; and determining a pressure indicator value based on the estimated mechanical component force and the position of the mechanical component. The method further includes determining, based on the pressure indicator value, an estimated tire pressure using a mapping of pressure indicator values to tire pressures.

### BRIEF DESCRIPTION OF THE DRAWINGS

FIG. 1A illustrates an example system for estimating tire pressure, in accordance with some implementations.

FIG. 1B illustrates an example system for estimating tire pressure, in accordance with some implementations.

FIG. 2 illustrates an example block diagram of the components included in an electronic controller of FIG. 1A and FIG. 1B, in accordance with some implementations.

FIG. 3 is a flowchart of an example method for estimating tire pressure, in accordance with some implementations.

FIG. 4 illustrates an example diagram of the inputs utilized and outputs generated as tire pressure estimation is performed, in accordance with some implementations.

FIG. 5 is flowchart of an example method for estimating tire pressure, in accordance with some implementations.

FIG. 6 is an example graph of a position of a mechanical component as a test routine is performed, in accordance with some implementations.

FIG. 7 is an example graph of pressure indicator values determined as a test routine is performed, in accordance with some implementations.

FIG. 8 is an example graph of pressure indicator values determined for a left front tire as a test routine is performed, in accordance with some implementations.

FIG. 9 is an example graph of summed pressure indicator values determined for a left front tire as a test routine is performed, in accordance with some implementations.

FIG. 10 is an example graph of an estimated tire pressure for a left front tire based on the summed pressure indicator values of the graph of FIG. 9 determined for a left front as the test routine is performed, in accordance with some implementations.

FIG. 11 is an example graph of estimated mechanical component forces versus determined mechanical component positions, in accordance with some implementations.

FIG. 12 includes example graphs of estimated mechanical component force, determined mechanical component position, and estimated tire pressure over time, in accordance with some implementations.

FIG. 13 is an example block diagram illustrating data used to estimate tire pressure and an output generated when the tire pressure is estimated, in accordance with some implementations.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

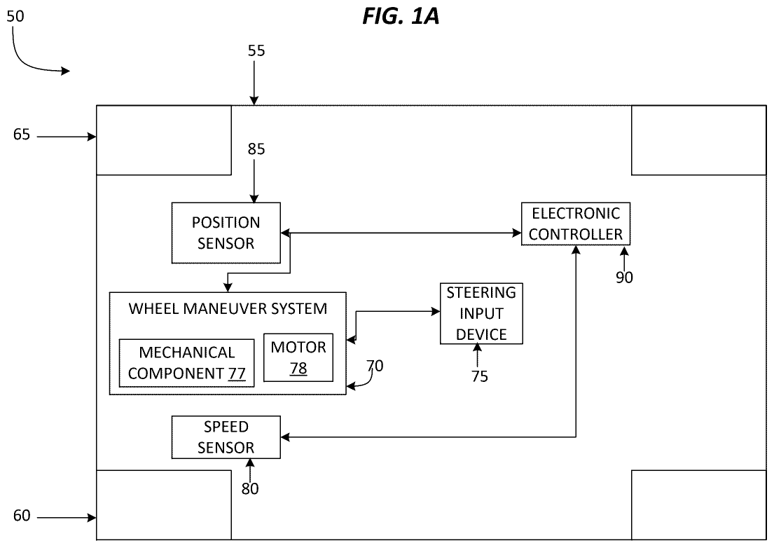

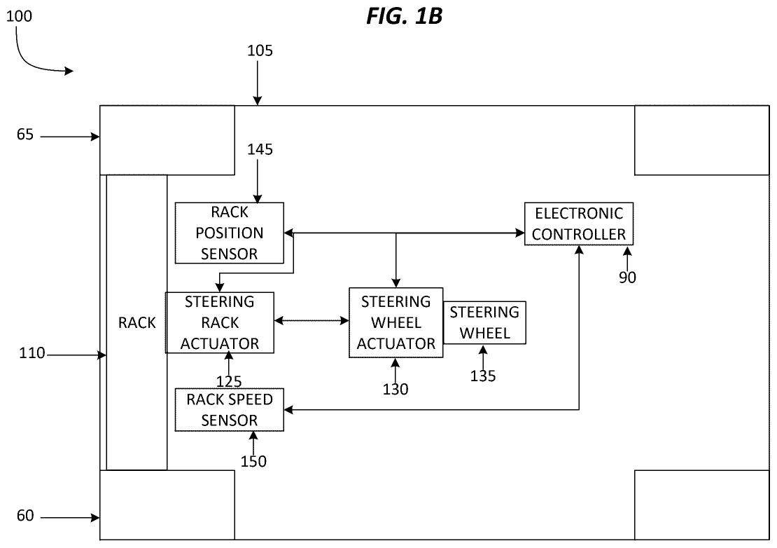

FIG. 1A illustrates an example system 50 for estimating tire pressure. In the implementation illustrated in FIG. 1A, the system 50 is included in a vehicle 55. While illustrated in FIG. 1A as a four-wheel vehicle, the vehicle 55 may be a different type of vehicle, for example, a two-wheel vehicle such as a motorcycle, a three-wheel vehicle such as a trike, or an eight-wheel vehicle such as a semi-truck. The vehicle 55 includes a steering system. The steering system illustrated in FIG. 1A may be one of a plurality of types of steering systems and the functionality described herein may be implemented in a plurality of types of steering systems. Therefore, the steering system illustrated in FIG. 1A is a generic representation of a steering system. The steering system of FIG. 1A includes a left front wheel 60, a right front wheel 65, a wheel maneuver system 70, and a steering input device 75. The wheel maneuver system 70 may include one or more mechanical or electrical components (for example, a mechanical component 77 and a motor 78) for turning the left front wheel 60 and the right front wheel 65. For example, the wheel maneuver system 70 may include a rack and pinion steering system, a recirculating ball steering system, or the like. The steering input device 75 is a device for receiving input from a driver to use to control the position of the left front wheel 60 and the right front wheel 65. The steering input device 75 may be for example, a steering wheel, a joystick, or the like. The system 50 also includes a speed sensor 80. In some implementations, the speed sensor 80 measures a speed of the mechanical component 77 used to turn the wheels 60, 65 left and right. In some implementations, the system 50 also includes a position sensor 85. The position sensor 85 may determine the angular displacement of the wheels 60, 65. For example, how far the wheels 60, 65 are shifted left of center or right of center. In some implementations, the position sensor 85 determines the angular displacement of the mechanical component 77 that turns the wheels left and right.

In some implementations, the electronic controller 90 is electrically and/or communicatively connected to the position sensor 85, the speed sensor 80, and the wheel maneuver system 70 via direct or indirect connections or by or through one or more control or data buses, which enable communication therebetween. In some implementations, the position sensor 85 and the speed sensor 80 may be electrically or communicatively connected to the wheel maneuver system 70 via direct or indirect connections or by or through one or more control or data buses, which enable communication therebetween. In some instances, the bus is a Controller Area Network (CAN™) bus. In some instances, the bus is an automotive Ethernet™, a FlexRay™ communications bus, or another suitable bus. In alternative instances, some or all of the components of the vehicle 55 may be communicatively connected using suitable wireless modalities (for example, Bluetooth™ or near field communication connections). Connections illustrated in FIG. 1A as being unidirectional may be, in some implementations, bidirectional. Connections illustrated in FIG. 1A as being bidirectional may be, in some implementations, unidirectional.

In some implementations, the position sensor 85 and the speed sensor 80 are included in the wheel maneuver system 70 (for example, positioned on or near the motor 78). In some implementations, the wheel maneuver system 70 includes one or more sensors that collect data needed to determine the force exerted on the mechanical component 77. For example, the wheel maneuver system 70 may include a sensor for measuring torque of the motor 78 included in the wheel maneuver system 70, a sensor for measuring a position of a rotor of the motor 78 included in the wheel maneuver system 70, and a sensor for measuring a velocity of the rotor of the motor 78 included in the wheel maneuver system 70.

The wheel maneuver system 70 may include an electronic processor, a memory, and a communication interface similar to the electronic processor, memory, and communication interface described below as being included in the electronic controller 90. In some implementations, all or some of the functionality described herein as being performed by the electronic controller 90 is performed by the wheel maneuver system 70.

In some implementations, the vehicle 55 may be equipped to perform rear wheel steering. In these implementations, the system 50 may include a second wheel maneuver system (including a second mechanical component that is configured to turn the rear wheels of the vehicle 55 and a second motor), a second position sensor, and a second speed sensor. Like the wheel maneuver system 70, speed sensor 80, and the position sensor 85, the second wheel maneuver system, second position sensor, and second speed sensor may be electrically and/or communicatively connected to the steering input device 75 and/or electronic controller 90. In some implementations, the second wheel maneuver system, second position sensor, and second speed sensor may be used to estimate the tire pressure of the rear tires of the vehicle 55 in a similar manner to how the wheel maneuver system 70, speed sensor 80, and the position sensor 85 are utilized to determine the tire pressure of the left front wheel 60 and the right front wheel 65, as described below.

FIG. 1B illustrates an example system 100 for estimating tire pressure in a vehicle 105 including a rack and pinion steering system. While illustrated in FIG. 1B as a four-wheel vehicle, the vehicle 105 may be a different type of vehicle, for example, a two-wheel vehicle such as a motorcycle, a three-wheel vehicle such as a trike, or an eight-wheel vehicle such as a semi-truck. In the illustrated implementation, the system 100 includes a steering system, specifically a rack and pinion steering system. The steering system of the vehicle 105 includes a rack 110, the left front wheel 60, the right front wheel 65, a steering rack actuator 125, a steering wheel actuator 130, and a steering wheel 135. The system 100 also includes the electronic controller 90, a rack position sensor 145, and a rack speed sensor 150. The steering wheel actuator 130 is mechanically coupled to the steering wheel 135. In some implementations, the steering wheel actuator 130 is also electrically and communicatively connected to the steering rack actuator 125. The steering rack actuator 125 is mechanically coupled to the rack 110. The rack is mechanically coupled to the left front wheel 60 and the right front wheel 65. In some implementations, the steering rack actuator 125 includes a motor for turning the rack 110 and thus the left front wheel 60 and the right front wheel 65. In some implementations the steering wheel actuator 130 that turns the steering wheel 135 or exerts a force on the steering wheel when the position of the rack changes.

In some implementations, the electronic controller 90 is electrically and/or communicatively connected to the rack position sensor 145, the rack speed sensor 150, the steering rack actuator 125, and the steering wheel actuator 130 via direct or indirect connections or by or through one or more control or data buses, which enable communication therebetween. In some implementations, the rack position sensor 145 and the rack speed sensor 150 may be electrically or communicatively connected to the steering rack actuator 125 via direct or indirect connections or by or through one or more control or data buses, which enable communication therebetween. In some instances, the bus is a Controller Area Network (CAN™) bus. In some instances, the bus is an automotive Ethernet™, a FlexRay™ communications bus, or another suitable bus. In alternative instances, some or all of the components of the vehicle 105 may be communicatively connected using suitable wireless modalities (for example, Bluetooth™ or near field communication connections). Connections illustrated in FIG. 1B as being unidirectional may be, in some implementations, bidirectional. Connections illustrated in FIG. 1B as being bidirectional may be, in some implementations, unidirectional.

In some implementations, the rack position sensor 145 and the rack speed sensor 150 are included in the steering rack actuator 125. In some implementations, the steering rack actuator 125 includes one or more sensors that collect data needed to determine the force exerted on the rack 110. For example, the steering rack actuator 125 may include a sensor for measuring torque of the motor included in the steering rack actuator 125, a sensor for measuring a position of a rotor of the motor included in the steering rack actuator 125, and a sensor for measuring a velocity of the rotor of the motor included in the steering rack actuator 125.

The steering rack actuator 125 and steering wheel actuator 130 may each include an electronic processor, a memory, and a communication interface similar to the electronic processor, memory, and communication interface described below as being included in the electronic controller 90. In some implementations, all or some of the functionality described herein as being performed by the electronic controller is performed by the steering rack actuator 125 or the steering wheel actuator 130.

In some implementations, the vehicle 105 may be equipped to perform rear wheel steering. In these implementations, the system 100 may include a second rack that is configured to turn the rear wheels of the vehicle 105, a second steering rack actuator, a second rack position sensor, and a second rack speed sensor. Like the steering rack actuator 125, rack speed sensor 150, and the rack position sensor 145, the second steering rack actuator, second rack position sensor, and second rack speed sensor may be electrically and/or communicatively connected to the steering wheel actuator 130 and/or electronic controller 90. In some implementations, the second steering rack actuator, second rack position sensor, and second rack speed sensor may be used to estimate the tire pressure of the rear tires of the vehicle 105 in a similar manner to how the steering rack actuator 125, rack speed sensor 150, and the rack position sensor 145 are utilized to determine the tire pressure of the left front wheel 60 and the right front wheel 65, as described below.

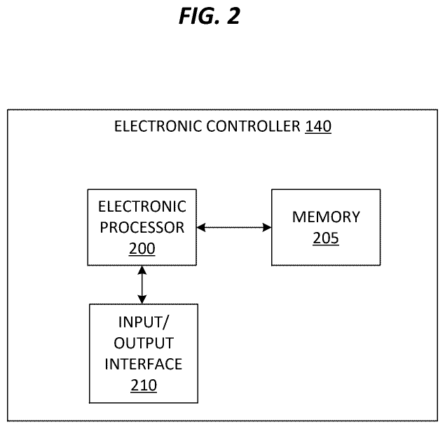

FIG. 2 illustrates an example of the components included in the electronic controller 90. In the example shown, the electronic controller 90 includes an electronic processor 200 (for example, a microprocessor, application specific integrated circuit, etc.), a memory 205, and a communication interface 210. The memory 205 may be made up of one or more non-transitory computer-readable media. The memory 205 can include combinations of different types of memory, such as read-only memory (“ROM”), random access memory (“RAM”), electrically erasable programmable read-only memory (“EEPROM”), flash memory, or other suitable memory devices. The electronic processor 200 is coupled to the memory 205 and the communication interface 210. The electronic processor 200 sends and receives information (for example, from the memory 205 and/or the communication interface 210) and processes the information by executing one or more software instructions or modules, capable of being stored in the memory 205, or another non-transitory computer readable medium. The software can include firmware, one or more applications, program data, filters, rules, one or more program modules, and other executable instructions. In some examples, the electronic processor 200 is configured to retrieve from the memory 205 and execute, among other things, software for performing methods as described herein.

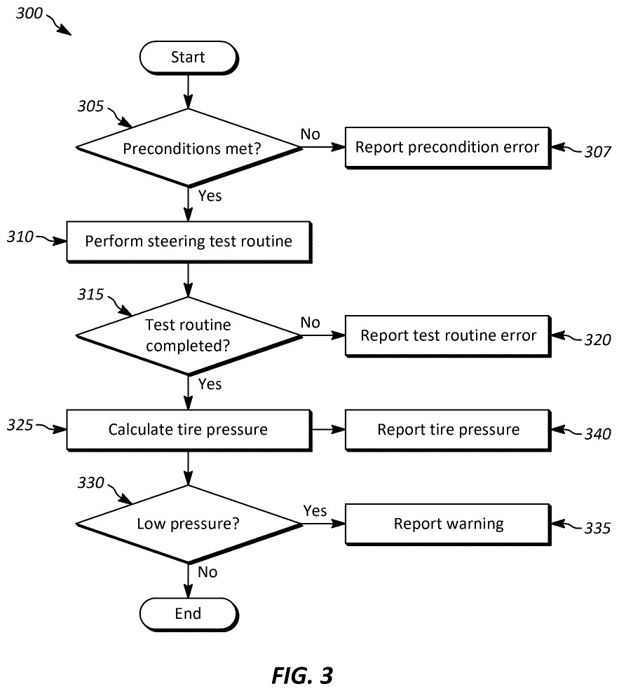

FIG. 3 is a flowchart of an example method 300 for estimating tire pressure. In some implementations, the method 300 begins at block 305 when the electronic processor 200 determines whether one or more preconditions are met and in response to determining one or more preconditions are met, at block 310, controls a motor (for example, a motor included in a steering rack actuator) to move a mechanical component (for example, a rack) of a vehicle left and right. For example, the one or more preconditions may include the mechanical component 77 being centered, the speed of the vehicle 55 being 0, the vehicle 55 being in park, a combination of the foregoing, or the like.

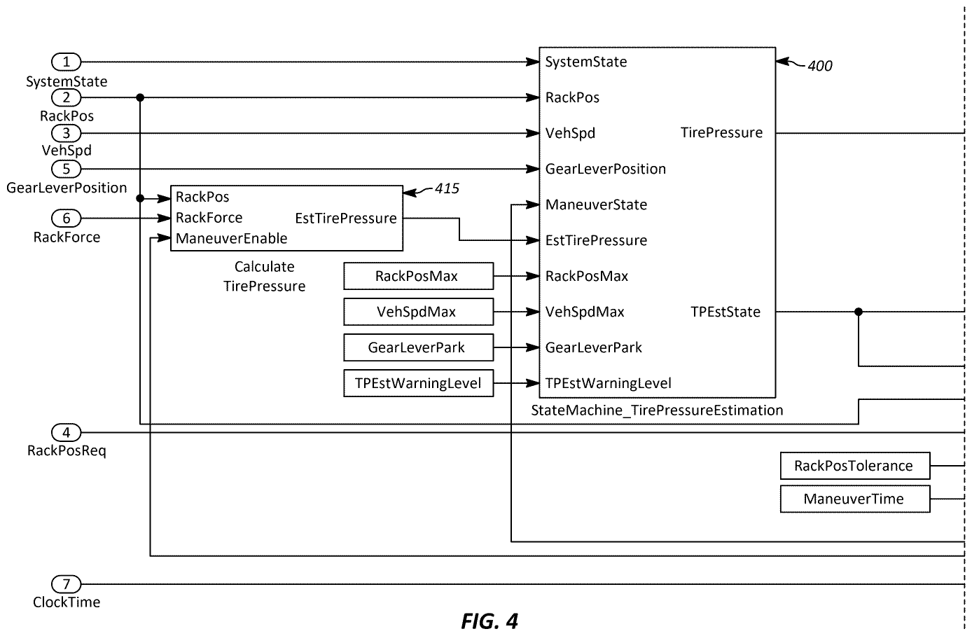

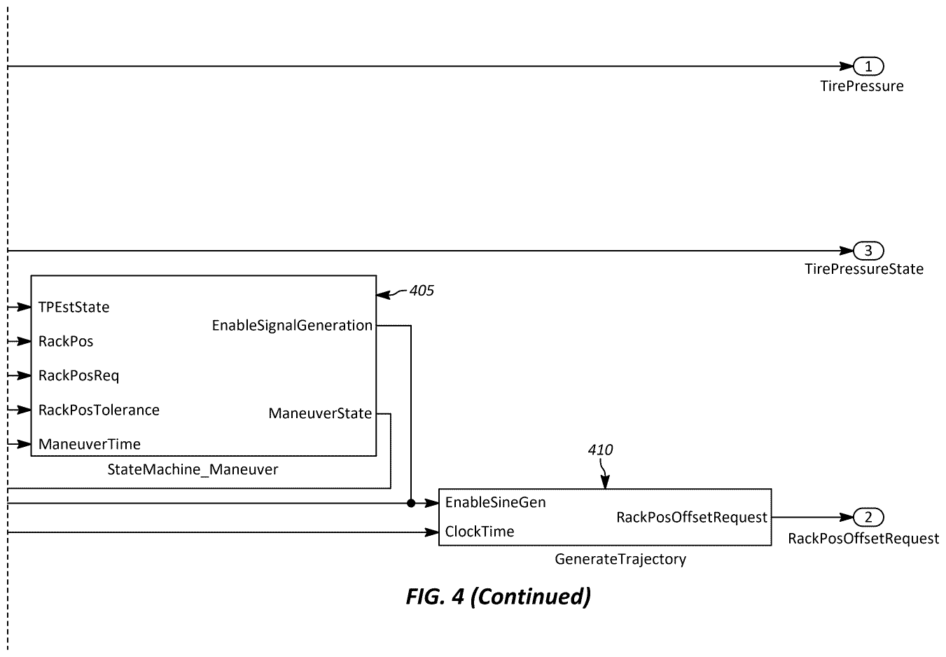

FIG. 4 illustrates an example diagram of the inputs utilized and outputs generated as tire pressure estimation is performed by the electronic processor 200 in a vehicle including a rack and pinion steering system (for example, the vehicle 105). Example inputs or data utilized by the electronic processor 200 may include an indication of the health of the steering system (represented by the variable “SystemState” in FIG. 4), a determined position of the rack 110 in meters (represented by the variable “RackPos” in FIG. 4), a speed of the vehicle 105 in kilometers per hour (kph) (represented by the variable “VehSpd” in FIG. 4), an indication of a gear lever position (for example, park, neutral, drive, or the like) of the vehicle 105 (represented by the variable “GearLeverPosition” in FIG. 4), an estimated force on the rack 110 in Newtons (represented by the variable “RackForce” in FIG. 4), a requested rack position in meters (represented by the variable “RackPosReq” in FIG. 4), a clock time kept by the electronic processor 200 (represented by the variable “ClockTime” in FIG. 4), a combination of the foregoing, or the like.

Block 400 represents a state machine (“StateMachine_TirePressureEstimation”) that the electronic processor 200 may transition through the states described below to ensure tire pressure is estimated with a high confidence level. The state machine represented by block 400 may include the state “Initialize.” The state machine represented by block 400 may enter the state “Initialize” when the vehicle 105 starts up. In the state “Initialize,” the electronic processor 200 may set a variable representing an estimated tire pressure (“TirePressure”) to a default value (for example, 100 pounds per square inch (PSI)) indicating that data needed to estimate the tire pressure is not available and may set the variable “TPEstState” to 0 or the state “Unknown.” In some implementations, the value assigned to the variable “TPEstState” indicates a portion of the tire pressure estimation functionality being performed, whether an error occurred during the tire pressure estimation, whether tire pressure was successfully estimated, a combination of the foregoing, or the like.

As described above, in some implementations, prior to estimating the tire pressure one or more preconditions must be met. In some implementations, when the one or more preconditions are not met, the electronic processor 200 transitions the state machine represented by the block 400 to the state “PrecondError.” In the state “PrecondError”, the electronic processor 200 may set the variable “TirePressure” to a default value (for example, 100PSI) and the variable “TPEstState” to 5 or the state “PreconditionError.” Returning to FIG. 3, when the one or more preconditions are not met, at block 307, the electronic processor 200 may generate and send an error message to one or more systems included in the vehicle 105 (for example, a braking system, a cruise control system, or the like) via, for example, a CAN™ bus. The error message may indicate that an alternative tire pressure estimation (for example, a tire pressure estimated when the vehicle 105 is in motion) should be utilized.

In some implementations, when the one or more preconditions are met, the electronic processor 200 transitions the state machine represented by block 400 to the state “Steer.” In the state “Steer,” the electronic processor 200 may set the variable “TirePressure” to 100PSI and the variable “TPEstState” to 1, representing the state “Steer.” In the state “Steer,” the electronic processor 200 may begin a steering test routine or maneuver used to estimate tire pressure. To perform the steering test routine, the electronic processor 200 may execute the state machine “StateMachine_TestRoutine” represented by block 405 and described in further detail below.

In some implementations, the electronic processor 200 executes the state machine represented by the block 405 to control and monitor the steering test routine used to estimate tire pressure. In some implementations, the state machine represented by the block 405 enters an “Initialize” state when the vehicle 105 starts up. In some implementations, when the variable “TPEstState” equals 1 (Steer), the state machine represented by block 405 enters a “Steer” state. When the state machine represented by the block 405 is in the state “Steer,” the electronic processor 200 may perform the functionality represented by the block 410 labeled “GenerateTrajectory” and start a timer. At block 410, the electronic processor 200 generates a sine wave to utilize to steer the rack 110 of the vehicle 105 or the rack 110 of the vehicle 105 a predetermined distance left of center and the predetermined distance right of center repeatedly over a predetermined period. For example, a sine wave with a 5 millimeter (mm) amplitude and a 1 Hertz (Hz) frequency is generated by the electronic processor 200 and the predetermined period is 5 seconds. In this example, the electronic processor 200 may send a signal to the steering rack actuator 125 to turn the rack 110 and, therefore the wheels 60 and 65, 5 mm to the left of center and 5 mm to the right of center. When the predetermined period is 5 seconds and the frequency of the sine wave is 1Hz, the rack 110 is turned 5 mm to the left five times and 5 mm to the right 5 times.

In some implementations, when the test routine is interrupted or some of the preconditions are violated before the test routine completes (for example, when the vehicle 105 is shifted into drive or the rack 110 is moved outside of the movement required by the test routine), the electronic processor 200 transitions the state machine represented by block 405 to the state “TestRoutineDeviation.” In the state “TestRoutineDeviation,” the electronic processor 200 may determine whether the preconditions (for example, the preconditions described in relation to block 305) are met, and when the preconditions are met, the state machine represented by block 405 may transition back to the “Steer” state. When the preconditions are not met for at least a predetermined amount of time, the electronic processor 200 may transition the state machine represented by block 405 to a “TestRoutineError” state. In the “TestRoutineError” state, the electronic processor 200 reports that the test routine was incomplete. In some implementations, when the test routine completes, the electronic processor 200 transitions the state machine represented by block 405 to the state “TestRoutineComplete.” In the “TestRoutineComplete” state, the electronic processor 200 reports that the test routine is complete.

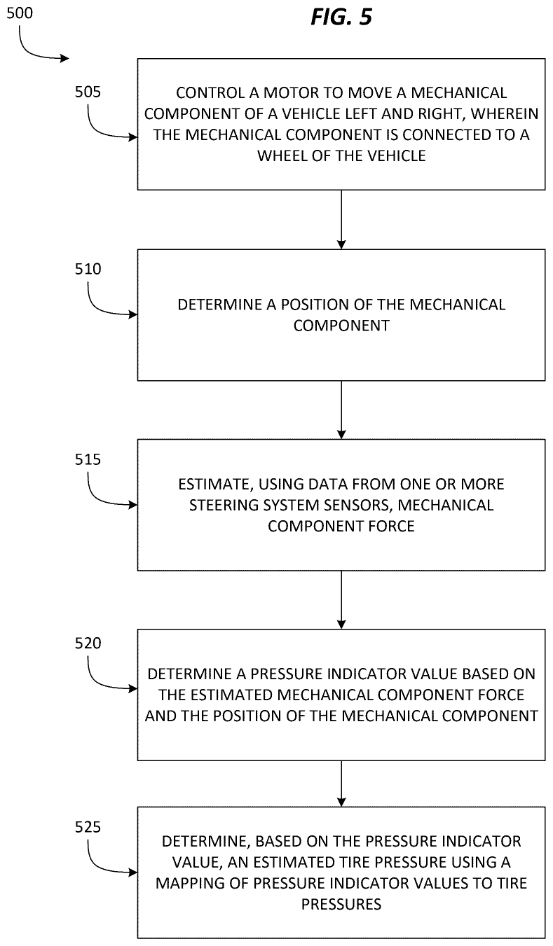

Returning to FIG. 3, in some implementations, at block 310, the electronic processor 200 performs the test routine. At block 315, the electronic processor 200 may determine whether the test routine completes. When the test routine does not complete, the electronic processor 200, may, at block 320, generate and send an error message to one or more systems included in the vehicle 55 (for example, a braking system, a cruise control system, or the like) via, for example, a CAN™ bus. The error message may indicate that an alternative tire pressure estimation (for example, a tire pressure estimated when the vehicle 55 is in motion) should be utilized. When the test routine completes, at block 325, the electronic processor 200 may estimate tire pressure. Details regarding how tire pressure are estimated are described below in relation to FIG. 5.

Returning to the state machine represented by block 405, when the test routine is interrupted, a precondition is violated, or the like before the test routine completes, the electronic processor 200 may transition the state machine represented by block 405 to a “TestRoutineError” state. In the “TestRoutineError” state, set the variable “TirePressure” to a default value (for example, 100PSI), and set the variable “TPEstState” to 6 or “TestRoutineError” state.

In some implementations, when the test routine completes successfully, the electronic processor 200 transitions the state machine represented by block 400 to a “CalculateTirePressure” state. In the state “CalculateTirePressure,” the electronic processor 200 may perform the functionality described in relation to block 415 labeled “CalculateTirePressure” (described in further detail below in relation to FIG. 5). In the state “CalculateTirePressure,” the electronic processor 200 may set the variable “TirePressure” to the tire pressure estimated by the electronic processor 200 when the electronic processor 200 performs the functionality described in relation to block 415. When the estimated tire pressure is greater than or equal to a predetermined threshold, the electronic processor 200 may set the variable “TPEstState” to 2 or a “NormalPressure” state. When the estimated tire pressure is below the predetermined threshold, the electronic processor 200 may set the variable “TPEstState” to 3 or a “LowPressure” state.

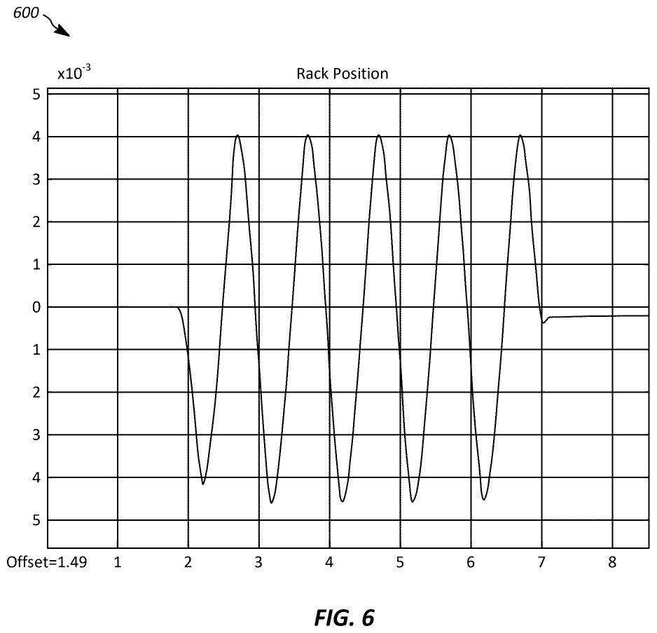

FIG. 5 is flowchart of an example method 500 for estimating tire pressure. In some implementations, the method 500 begins at block 505 when the electronic processor 200 control a motor (for example, the motor 78 or a motor included in the steering rack actuator 125) to move a mechanical component (for example, the mechanical component 77 or the rack 110) of a vehicle (for example, the vehicle 55 or the vehicle 105) left and right. In some implementations the electronic processor 200 may control the motor 78 to steer the mechanical component 77 of the vehicle 55 a predetermined distance left of center (for example, 5 mm) and the predetermined distance right of center (for example, 5 mm) repeatedly over a predetermined time period (for example, 5 seconds) at a predetermined frequency (for example, 1 Hz). Moving the mechanical component 77 of the vehicle 55 to the left and right multiple times, prevents outliers during any one turn to the left or right from overly affecting the estimated tire pressure. In some implementations, the electronic processor 200 disables a feedback motor attached to the steering wheel 135 or steering input device 75 (for example, a feedback motor included in the steering wheel actuator 130) when controlling the steering rack actuator 125 or motor 78 to move the rack 110 or mechanical component 77 left and right at block 505. FIG. 6 is an example graph 600 of the position of the mechanical component 77 as the test routine is performed. The y-axis of the graph 600 represents the position of the mechanical component 77 in meters and the x-axis represents time in seconds.

In some implementations, at block 510, the electronic processor 200 determines a position of a mechanical component (for example, the mechanical component 77 or the rack 110). For example, the electronic processor 200 may determine the position of the rack 110 based on data from the rack position sensor 145 or the position of the mechanical component 77 based on data from the position sensor 85.

In some implementations, at block 515, the electronic processor 200, estimates, using data from one or more steering system sensors (for example, a sensor for measuring torque of the motor 78 (or the motor included in the steering rack actuator 125), a sensor for measuring a position of a rotor of the motor 78 (or the motor included in the steering rack actuator 125), and a sensor for measuring a velocity of the rotor of the motor 78 (or the motor included in the steering rack actuator 125), combination of the foregoing, or the like), mechanical component force. For example, the electronic processor 200 may utilize steering torque (for example, the torque produced by the motor 78, a torque associated with the steering input device 75, or both depending on the type of steering system), a speed at which the mechanical component 77 (or rack 110) is turning, a torque of the motor 78 (or a motor included in the steering rack actuator 125) to estimate the mechanical component force. A variety of techniques may be used to estimate the mechanical component force using data from one or more steering system sensors. For example, a Kalman Filter may be utilized to estimate mechanical component force or a steering-gear-model may be utilized to estimate mechanical component force.

While methods for estimating mechanical component force that do not rely on only data from steering system sensors exist, these methods produce accurate mechanical component force estimates when the vehicle is traveling above a speed of 20 kilometers per hour (kph). Below 20kph, the mechanical component force estimates produced by methods that do not rely on only data from steering system sensors do not correlate well to true mechanical component force. Since the implementations described herein estimate tire pressure before the vehicle begins traveling (when the vehicle is in park), methods for estimating mechanical component force that do not rely on only data from steering system sensors are not utilized by the electronic processor 200 to perform the implementations described herein.

In some implementations, at block 520, the electronic processor 200 determines a pressure indicator value based on the estimated mechanical component force and the position of the mechanical component. In some implementations, the pressure indicator value is a sum of the estimated mechanical component force squared and the position of the mechanical component (for example, the mechanical component 77) squared. In some implementations, prior to block 520, the electronic processor 200 normalizes the mechanical component position and the mechanical component force. In some implementations, Equation 1 is the equation utilized by the electronic processor 200 to determine the pressure indicator value.

PressureIndicator=MechanicalComponentForce²+MechanicalComponentPosition² (1)

In other implementations, Equation 2 is the equation utilized by the electronic processor 200 to determine the pressure indicator value.

PressureIndicator=|MechanicalComponentForce|+|MechanicalComponentPosition| (2)

In other implementations, Equation 3 is the equation utilized by the electronic processor 200 to determine the pressure indicator value.

PressureIndicator=\sqrt{MechanicalComponentForce2+MechanicalComponentPosition2} (3)

Equations other than those provided herein may be used to determine the pressure indicator value.

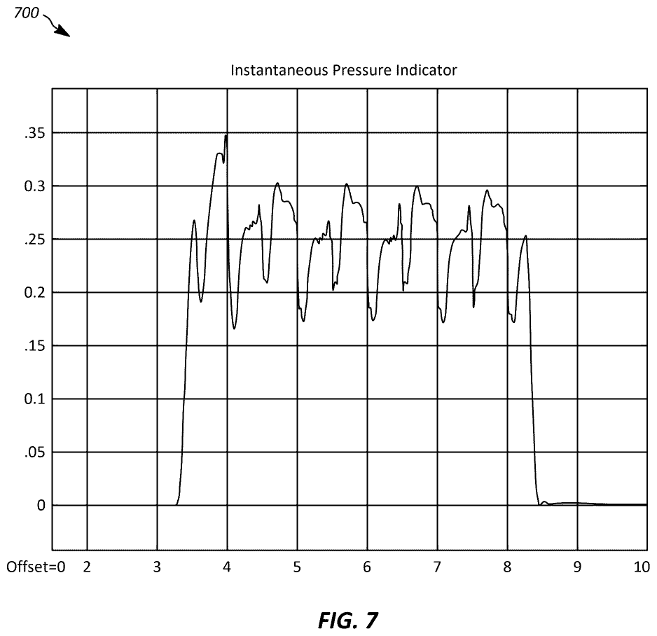

FIG. 7 is an example graph 700 of pressure indicator values determined as the test routine is performed. In the graph 700, the y-axis represents pressure indicator values and the x-axis represents time in seconds.

In some implementations, the electronic processor 200 determines a wheel associated with the pressure indicator value. An estimated mechanical component force may be a result of a tire being compressed. For example, when, like in the example vehicle 105 illustrated in FIG. 1B, the rack 110 is connected to two wheels, and the rack 110 is steered to the left, the left front tire of the vehicle 105 is being compressed. Therefore, the mechanical component force estimated when the rack 110, and thus the left front wheel 60 is turned to the left, is a function of the pressure in the left front tire. Similarly, when the rack 110 is turned to the right, the estimated mechanical component force is a function of the pressure in the right front tire. Therefore, tire pressure of the individual tires can be calculated during the same test routine when the mechanical component 77 is moved to the left of center and to the right of center.

In some implementations, two separate pressure indicator values may be calculated based on the direction the mechanical component 77 is turning or the velocity of the mechanical component 77. When the mechanical component 77is moving towards the left of center, a pressure indicator value associated with the left front wheel 60 may be calculated. When the mechanical component 77 is moving towards the right of center, a pressure indicator value associated with the right front wheel 65 may be calculated. For example, the electronic processor 200 determines a mechanical component velocity and the electronic processor 200, in response to determining that the mechanical component velocity is greater than a predetermined threshold (for example 0.001), determines the pressure indicator value is associated with a left wheel (for example, if MechanicalComponentVelocity >0.001, InstantaneousLeftPressureIndicator =PressureIndicator). The electronic processor 200 may, in response to determining that the mechanical component velocity is less than the predetermined threshold (for example 0.001), determine the pressure indicator value is associated with a right wheel (for example, if MechanicalComponentVelocity<0.001, InstantaneousRightPressureIndicator=PressureIndicator).

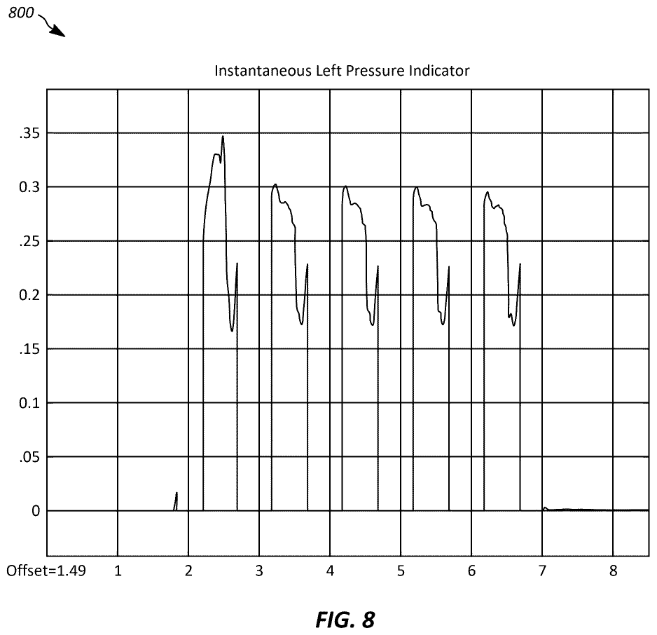

FIG. 8 is an example graph 800 of pressure indicator values determined for a left front wheel (for example, the left front wheel 60) as the test routine is performed. In the graph 800, the y-axis represents pressure indicator values determined for a left front wheel and the x-axis represents time in seconds.

In some implementations, the electronic processor 200 determines an average pressure indicator value by averaging pressure indicator values determined for a wheel over the predetermined period of time (for example, 5 seconds) that the mechanical component 77 moves during the test routine.

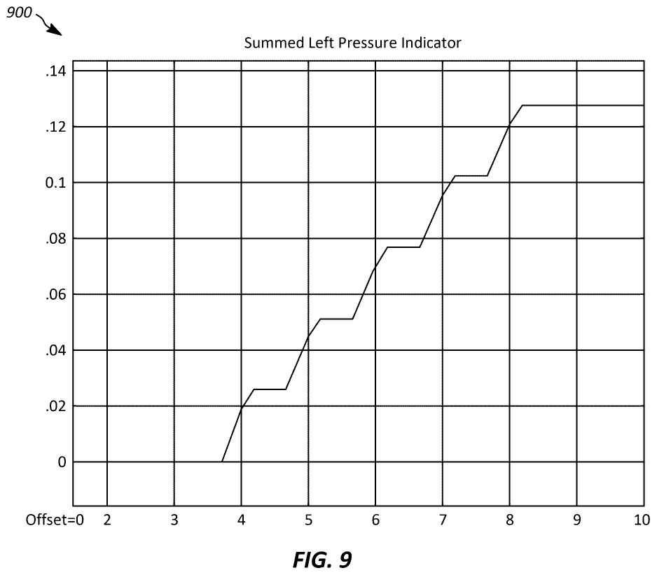

FIG. 9 is an example graph 900 of summed pressure indicator values determined for a left front wheel (for example, the left front wheel 60) as the test routine is performed. In the graph 900, the y-axis represents summed pressure indicator values determined for a left front wheel and the x-axis represents time in seconds. In the example graph 900, while a right tire is being compressed, the pressure indicator value for the left tire is zero. Therefore, the summed pressure indicator value for the left tire does not change while the right tire is compressed. When the mechanical component 77 moves back towards the left, the pressure indicator value for the left tire becomes non-zero again and the summed pressure indicator value determined for a left front wheel starts increasing again. When the predetermined time period ends and the electronic processor 200 ceases controlling a motor to move a mechanical component left and right, the electronic processor 200 may divide the summed pressure indicator values determined for a left front wheel by the number of times the mechanical component 77 turned to the left to determine the average pressure indicator value determined for the left front wheel.

In some implementations, at block 525, the electronic processor 200 determines, based on the pressure indicator value, an estimated tire pressure using a mapping of pressure indicator values to tire pressures. In some implementations, the electronic processor 200 determines, based on the pressure indicator value for the right front wheel 65, an estimated tire pressure for the right front wheel 65 using a mapping of pressure indicator values to tire pressures. The mapping may be stored in the memory 205 and determined experimentally by test engineers and/or software developers. In some implementations, the electronic processor 200 determines, based on the pressure indicator value for the left front wheel 60, an estimated tire pressure for the left front wheel 60 using the mapping of pressure indicator values to tire pressures.

In some implementations, the electronic processor 200 determines, based on the average pressure indicator value, an estimated tire pressure using a mapping of pressure indicator values to tire pressures. In some implementations, the electronic processor 200 determines, based on the average pressure indicator value determined for the right front wheel 65, an estimated tire pressure for the right front wheel 65 using the mapping of pressure indicator values to tire pressures. In some implementations, the electronic processor 200 determines, based on the average pressure indicator value determined for the left front wheel 60, an estimated tire pressure for the left front wheel 60 using the mapping of pressure indicator values to tire pressures.

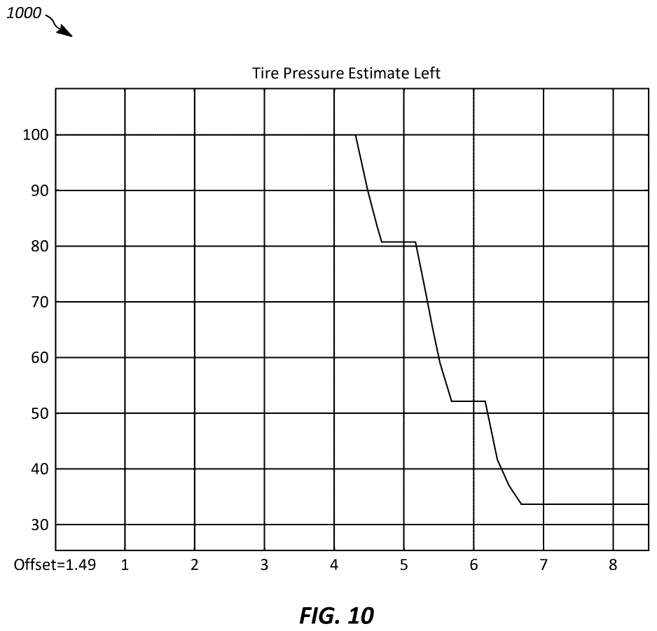

FIG. 10 is an example graph 1000 of an estimated tire pressure for a left front wheel (for example, the left front wheel 60) based on the summed pressure indicator values determined for a left front wheel (for example, the left front wheel 60) as the test routine is performed. In the graph 1000, the y-axis represents an estimated tire pressure value and the x-axis represents time in seconds.

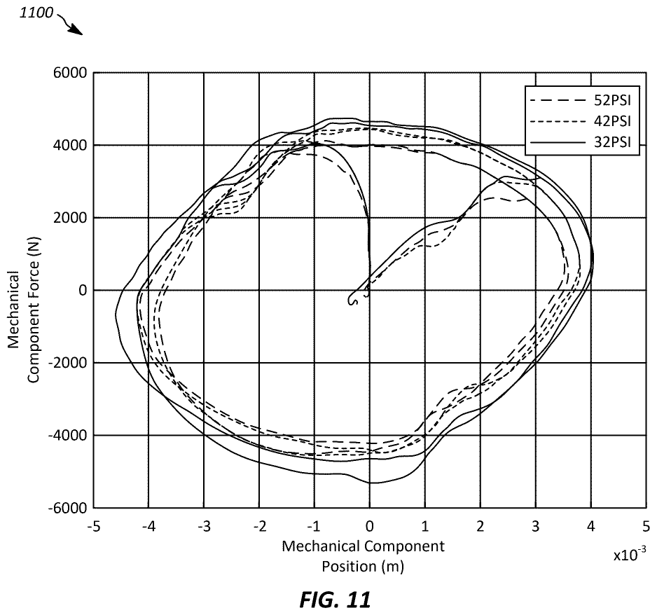

FIG. 11 is an example graph 1100 of estimated mechanical component forces versus determined mechanical component positions. The y-axis of the graph 1100 represents estimated mechanical component forces in Newtons and the x-axis of the graph 1100 represents determined mechanical component positions in meters. The graph 1100 includes three different circles corresponding to three different tire pressure estimates (for example, tire pressure estimates for three different tires). The radius of a circle included in the graph 1100 may correspond to the pressure indicator values calculated when the method 500 is performed. In some implementations, when the mechanical component force is greater than 0, points included in a circle are associated with a left tire and, when the mechanical component force is less than 0, points included in a circle are associated with a right tire.

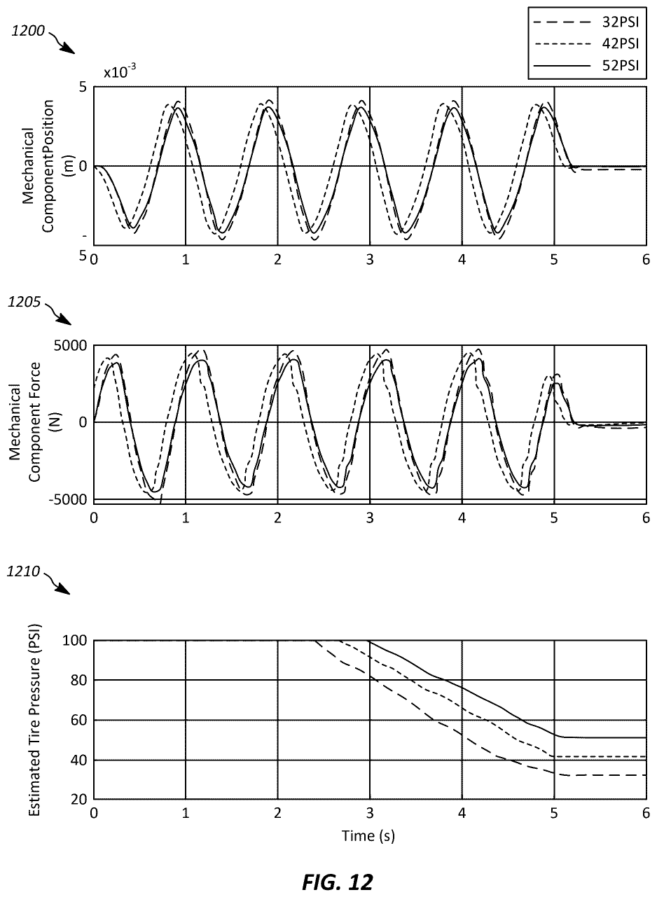

FIG. 12 includes example graphs of estimated mechanical component force, determined mechanical component position, and estimated tire pressure over time (for example, over the predetermined time period when the test routine is performed). The y-axis of the graph 1200 represents the estimated mechanical component force in Newtons, the y-axis of the graph 1205 represents the determined mechanical component position in meters, the y-axis of the graph 1210 represents the estimated tire pressure in PSI. The x-axis of each of the graphs 1200, 1205, and 1210 represents time in seconds. As in the graph 1100, the graphs 1200, 1205, and 1210 include data corresponding to three different tire pressure estimates (for example, tire pressure estimates for three different tires).

Returning to FIG. 3, in some implementations, the electronic processor 200, in response to determining the estimated tire pressure is below a predetermined threshold at block 330, generates a warning at block 335. The electronic processor 200 may send the warning to an output device via, for example, a CAN™ bus. For example, the warning may be output by displaying a message via a heads-up display included in the vehicle 55, outputting a message via a speaker included in the vehicle, or illuminating a warning light included in a dashboard of the vehicle 55. In some implementations, the output warning includes an indication of which tire(s) are associated with an estimated tire pressure associated below a predetermined threshold. In some implementations, at block 340, the electronic processor 200 utilizes the estimated tire pressure to control an anti-lock braking system of the vehicle 55, a stability control system of the vehicle 55, the steering system of the vehicle 55, an active or semi-active suspension control system of the vehicle 55, a combination of the foregoing, or the like. For example, the estimated tire pressure may be utilized to adapt steering feel calibrations. In some implementations, the feedback motor included in the steering wheel actuator 130 of the vehicle 105 may decrease torque output on the steering wheel 135 as the estimated tire pressure decreases. In another example, the estimated tire pressure may be utilized by the active or semi-active suspension control system of the vehicle 55 to decrease the load on a tire with an estimated tire pressure below a predetermined threshold.

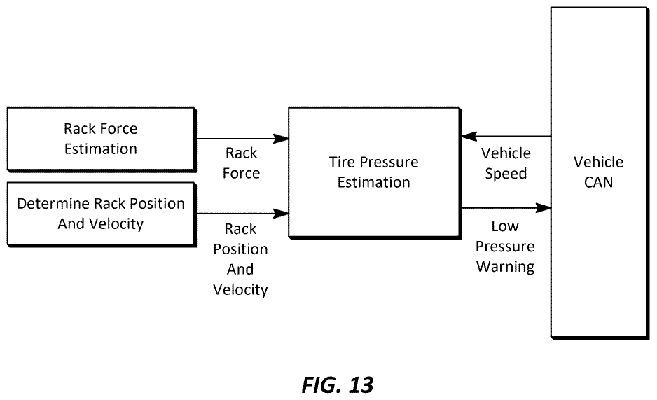

FIG. 13 is an example block diagram illustrating data used by the electronic processor 200 to estimate tire pressure in a rack and pinion steering system and an output generated when the tire pressure is estimated. In some implementations, the electronic processor 200 may receive a speed of the vehicle 105 via a CAN™ bus and utilize the speed of the vehicle to determine whether one or more preconditions are met. The electronic processor 200 may estimate a tire pressure as described above using an estimated mechanical component force and mechanical component position. In some implementations, a mechanical component velocity may be utilized to determine whether an estimated tire pressure is associated with a left wheel or a right wheel. In some implementations, when an estimated tire pressure is below a predetermined threshold, the electronic processor 200 generates and sends a low pressure warning via the CAN™ bus.

Thus, examples, aspects, and features herein provide, among other things, systems and methods for estimating tire pressure.

What is claimed is:

1. A system for estimating tire pressure, the system comprising:
an electronic processor, the electronic processor configured to:
control a motor to move a mechanical component of a vehicle left and right,
wherein the mechanical component is connected to a wheel of the vehicle;
when the mechanical component is moving,
determine a position of the mechanical component;
estimate, using data from one or more steering system sensors, mechanical component force; and
determine a pressure indicator value based on the estimated mechanical component force and the position of the mechanical component; and
determine, based on the pressure indicator value, an estimated tire pressure using a mapping of pressure indicator values to tire pressures.

2. The system according to claim 1, wherein the mechanical component includes a rack, the wheel is a right wheel, the mechanical component is connected to the right wheel and a left wheel, and the electronic processor is further configured to:
determine a whether the left wheel or the right wheel is associated with the pressure indicator value.

3. The system according to claim 2, wherein the electronic processor is configured to determine whether the left wheel or the right wheel is associated with the pressure indicator value by:
determining a mechanical component velocity;
in response to determining that the mechanical component velocity is greater than a predetermined threshold, determine the pressure indicator value is associated with the left wheel; and
in response to determining that the mechanical component velocity is less than the predetermined threshold, determine the pressure indicator value is associated with the right wheel.

4. The system according to claim 1, wherein the electronic processor is further configured to:
in response to determining the estimated tire pressure is below a predetermined threshold, generate a warning.

5. The system according to claim 1, wherein the electronic processor is further configured to:
utilize the estimated tire pressure to control at least one selected from the group consisting of an anti-lock braking system, a stability control system, and a steering system.

6. The system according to claim 1, wherein the electronic processor is further configured to:
determine whether one or more preconditions are met; and
in response to determining one or more preconditions are met, control the motor to move the mechanical component of the vehicle left and right.

7. The system according to claim 1, wherein the electronic processor is further configured to control the motor to move:
the mechanical component of the vehicle a predetermined distance left of center and a predetermined distance right of center repeatedly over a predetermined period.

8. The system according to claim 7, wherein the electronic processor is further configured to:
determine an average pressure indicator value by averaging pressure indicator values determined for a wheel over the predetermined period; and
determine, based on the average pressure indicator value, the estimated tire pressure using the mapping of pressure indicator values to tire pressures.

9. The system according to claim 1, wherein the electronic processor is further configured to:
disable a feedback motor attached to a steering wheel when controlling the motor to move the mechanical component left and right.

10. The system according to claim 7, wherein the predetermined period is 5 seconds, the predetermined distance right of center is 5 millimeters, and the predetermined distance left of center is 5 millimeters.

11. A method for estimating tire pressure, the method comprising:
controlling a motor to move a mechanical component of a vehicle left and right, wherein the mechanical component is connected to a wheel of the vehicle;
when the mechanical component is moving,
determining a position of the mechanical component;
estimating, using data from one or more steering system sensors, mechanical component force; and
determining a pressure indicator value based on the estimated mechanical component force and the position of the mechanical component; and
determining, based on the pressure indicator value, an estimated tire pressure using a mapping of pressure indicator values to tire pressures.

12. The method according to claim 11, wherein the mechanical component includes a rack, the wheel is a right wheel, the mechanical component is connected to the right wheel and a left wheel, and the method further comprising:
determining a whether the left wheel or the right wheel is associated with the pressure indicator value.

13. The method according to claim 12, wherein determining whether the left wheel or the right wheel is associated with the pressure indicator value includes:
determining a mechanical component velocity;
in response to determining that the mechanical component velocity is greater than a predetermined threshold, determine the pressure indicator value is associated with the left wheel; and
in response to determining that the mechanical component velocity is less than the predetermined threshold, determine the pressure indicator value is associated with the right wheel.

14. The method according to claim 11, the method further comprising:
in response to determining the estimated tire pressure is below a predetermined threshold, generating a warning.

15. The method according to claim 11, the method further comprising:
utilizing the estimated tire pressure to control at least one selected from the group consisting of an anti-lock braking system, a stability control system, and a steering system.

16. The method according to claim 11, the method further comprising:
determining whether one or more preconditions are met; and
in response to determining one or more preconditions are met, controlling the motor to move the mechanical component of the vehicle left and right.

17. The method according to claim 11, wherein controlling the motor to move a mechanical component of a vehicle left and right includes:
controlling the motor to move the mechanical component of the vehicle a predetermined distance left of center and a predetermined distance right of center repeatedly over a predetermined period.

18. The method according to claim 17, the method further comprising:
determining an average pressure indicator value by averaging pressure indicator values determined for a wheel over the predetermined period; and
determining, based on the average pressure indicator value, the estimated tire pressure using the mapping of pressure indicator values to tire pressures.

19. The method according to claim 11, the method further comprising:
disabling a feedback motor attached to a steering wheel when control the motor to move the mechanical component of the vehicle left and right.

20. The method according to claim 17, wherein the predetermined period is 5 seconds, the predetermined distance right of center is 5 millimeters, and the predetermined distance left of center is 5 millimeters.
